(19) United States
(12) Patent Application Publication
(10) Pub. No.: US 2014/0054311 A1
(43) Pub. Date: Feb. 27, 2014

(54) AUTOMATIC VENDING MACHINE WITH MOVING MEMBER FOR PRODUCTS

(71) Applicants: HONG FU JIN PRECISION INDUSTRY (WUHAN) CO., LTD., Wuhan City (CN); HON HAI PRECISION INDUSTRY CO., LTD., Tu-Cheng (TW)

(72) Inventors: YUN-LUNG CHEN, Tu-Cheng (TW); CHUNG CHAI, Tu-Cheng (TW); DA-LONG SUN, Wuhan City (CN); SHENG-HE LI, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/627,012

(22) Filed: Sep. 26, 2012

(30) Foreign Application Priority Data
Aug. 21, 2012 (CN) 2012102979065

(51) Int. Cl. B65H 3/28; G07F 11/42

(52) U.S. Cl. 221/258; 221/277

(57) ABSTRACT

An automatic vending machine includes a chassis and a moving mechanism attached to the chassis. The chassis defines a channel configured for receiving products. The moving mechanism includes a moving member received in the channel, a driving assembly, and a mounting member attached to the driving assembly. The driving assembly is configured to rotate the moving member and includes a claw member. The claw member includes a plurality of clawers. The moving member moves the products when rotated by the driving assembly. The mounting member is moveable relative to the claw member between a first position to a second position. When the mounting member is located in the first position, and the moving member is located among the plurality of clawers. When the mounting member is located in a second position, the plurality of clawers are resiliently deformed by the mounting member to clamp the moving member.

### BACKGROUND

1. Technical Field

The present disclosure relates to automatic vending machines, more particularly to an automatic vending machine with a moving member for moving products.

2. Description of Related Art

In an automatic vending machine, a spring is used to deliver products when rotated by a motor. When a new product needs to be added to the automatic vending machine, the position of the spring may need to be adjusted. However, the position of the spring is usually hard to adjust.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric, cutaway view of an embodiment of an automatic vending machine.

FIG. 2 is an exploded, isometric, cutaway view of a side plate and a moving mechanism of the automatic vending machine of FIG. 1.

FIG. 3 is an exploded, isometric view of a driving assembly of the moving mechanism of FIG. 2.

FIG. 4 is an assembled view of the moving mechanism, and a mounting member is not shown.

FIG. 5 is a cross-sectional view of the mounting member.

FIG. 6 is an assembled, cutaway view of the automatic vending machine of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

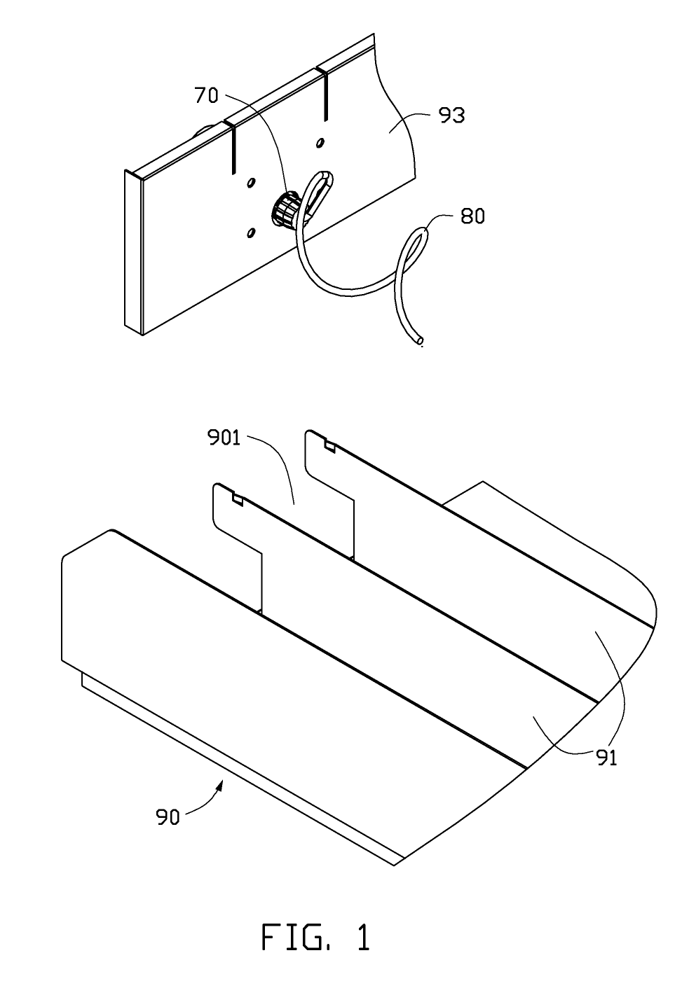

FIGS. 1-3 illustrate an embodiment of an automatic vending machine comprising a chassis 90 and a moving mechanism 200 attached to the chassis 90.

The chassis 90 defines a channel 901 configured for receiving products (not shown). The products may be, for example, drink contained in tins.

The moving mechanism 200 comprises a moving member 80 received in the channel 901, a driving assembly 100, and a mounting member 70 attached to the driving assembly 100. The driving assembly 100 is configured to rotate the moving member 80 and comprises a claw member 30. The claw member 30 comprises a plurality of clawers 33. The moving member 80 is configured to move the products when rotated by the driving assembly 100.

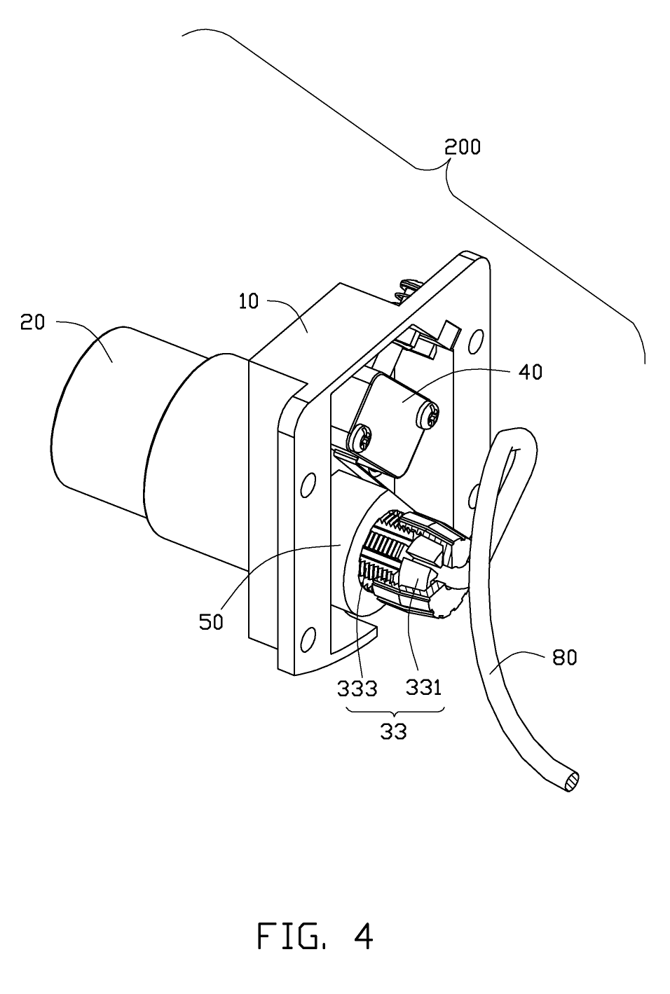

The mounting member 70 is moveable relative to the claw member 30 between a first position to a second position (shown in FIG. 4). When the mounting member 70 is located in the first position and the moving member 80 is located among the plurality of clawers 33. The mounting member 70 clamps the moving member 80, which resiliently deforms when the mounting member 70 is located in a second position, the plurality of clawers 33.

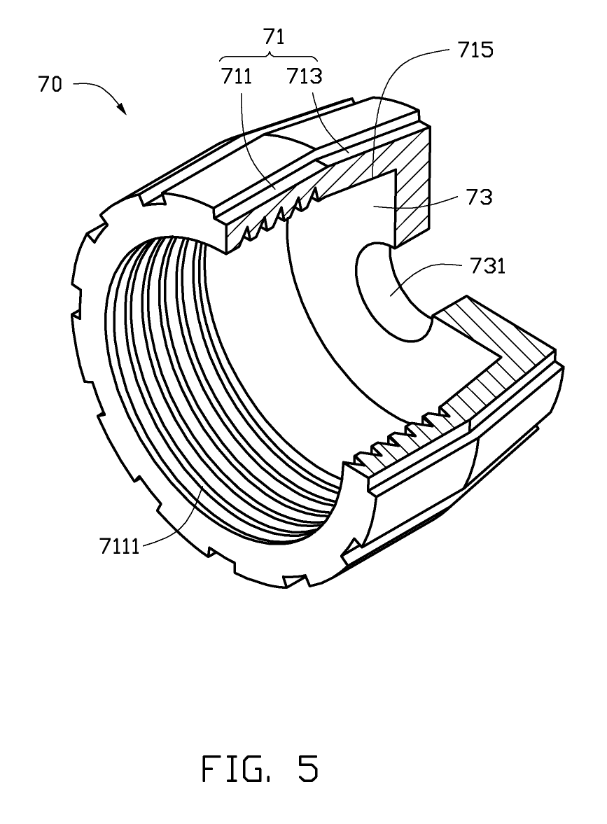

Each of the plurality of clawers 33 comprises a clamping portion 331, the mounting member 70 surrounds on the clamping portion 331 of each of the plurality of clawers 33 and defines a diagonal surface 715 (shown in FIG. 5). When the mounting member 70 is located in the second position, the plurality of clawers 33 are resiliently deformed by the diagonal surface 715 of the mounting member 70.

Each of the plurality of clawers 33 defines a plurality of outer threads 333, and the mounting member 70 defines a plurality of inner threads 7111 (shown in FIG. 5). When the mounting member 70 is moved between the first position and the second position, the plurality of inner threads 7111 are engaged with the plurality of outer threads 333.

Referring to FIGS. 1 and 4, the mounting member 70 further defines a through hole 731, and an end of the moving member 80 extends through the through hole 731 and positioned among the plurality of clawers 33.

The driving assembly 100 further comprises a rotating block 50 and a sensor 40. The rotating block 50 is secured to the plurality of clawers 33. In an embodiment, the rotating block 50 is integrated with the plurality of clawers 33. When the driving assembly 100 rotates the moving member 80, the sensor 40 detects rotational movements of the rotating block 50. The rotational movements may be sent to a system of the automatic vending machine to control rotations of the moving member 80.

The rotating block 50 comprises an arc surface 53 and a flat surface 51. A resilient piece 415 is attached to the sensor 40 and abuts on one of the arc surface 53 and the flat surface 51 (shown in FIG. 4). When the rotating block 50 is rotated, the rotating block 50 reciprocating the sensor 40.

The driving assembly 100 further comprises a case 10 and a motor 20. The rotating block 50 and the sensor 40 are received in the case 10. The motor 20 is secured to the case 10 and configured to rotating the rotating block 50 and the plurality of clawers 33 relative to the case 10. When the rotating block 50 is rotated, the sensor 40 is slid relative to the case 10. In an embodiment, the motor 20 comprises a rotation shaft, and the rotating block 50 is secured to the rotation shaft.

The driving assembly 100 further comprises a resilient member 47 and a post 43. The resilient member 47 is secured to the case 10. The post 43 is slidably secured to the case 10 and abuts against the sensor 40. The resilient member 47 is deformed to a first deformation when abutting against the flat surface 51 and a second deformation when abutting against the arc surface 53. An amount of deformation of the first deformation is less than an amount of deformation of the second deformation. For example, the sensor 40 abuts against the flat surface 51 of the rotating block 50, and the resilient member 47 has the first resilient deformation. At this time, the rotating block 50 is rotated have the arc surface 53 to abut against the sensor 40, and the sensor 40 is pushed to slide along a direction towards out of the case 10. The post 43 is pushed to slide by the sensor 40 and resiliently deforms the resilient member 47 to define the second resilient deformation. When the rotating block 50 is rotated to have the flat surface 51 to abut against the sensor 40 again, the resilient member 47 rebounds from the second resilient deformation to the first deformation to slide the push the post 43 in the case 10. The sensor 40 is pushed by the post 43 to slide to abut the flat surface 51.

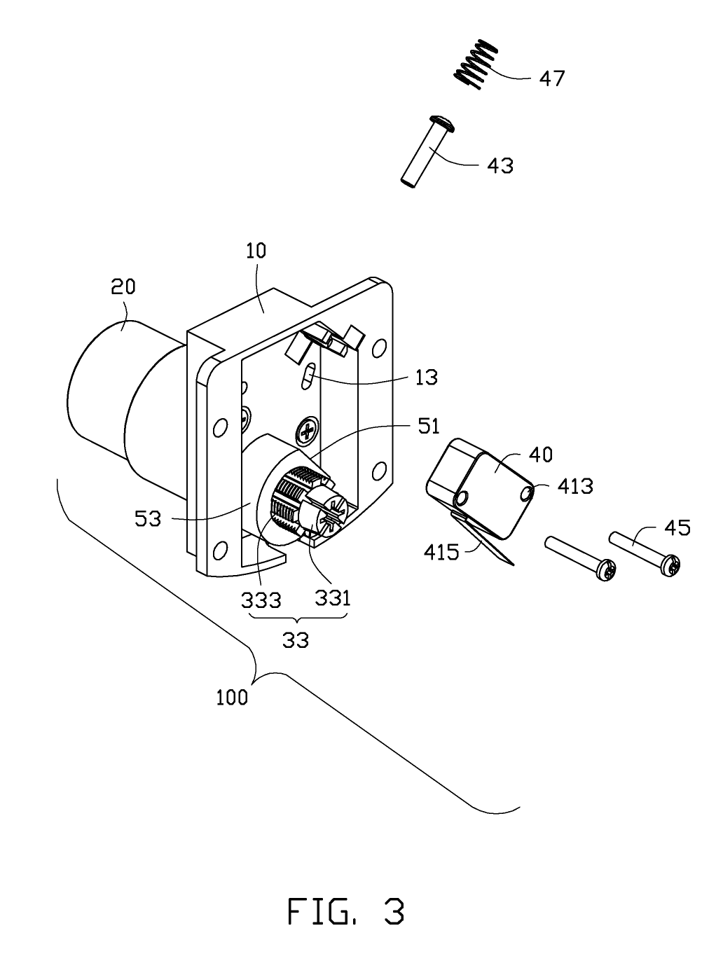

Referring to FIG. 3, the case 10 defines two sliding slots 13. The driving assembly 100 further comprises two fasteners 45. The sensor 40 defines two securing holes 413. Referring also to FIG. 4, the two fasteners 45 are inserted through the two securing holes 413 and engaged in the two sliding slots 13, so that the sensor 40 is slidably secured to the case 10.

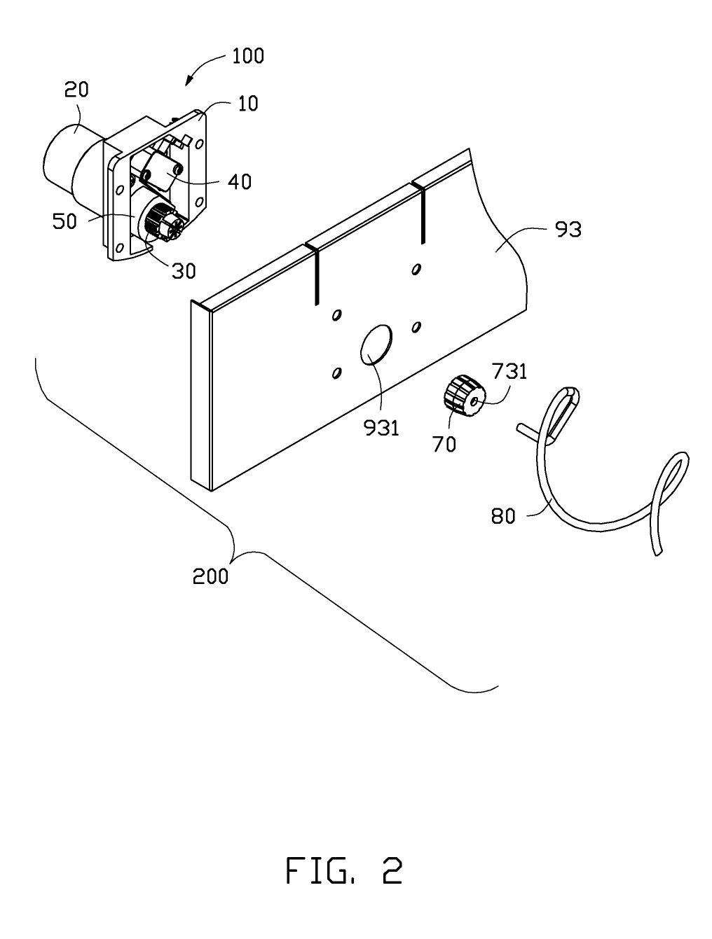

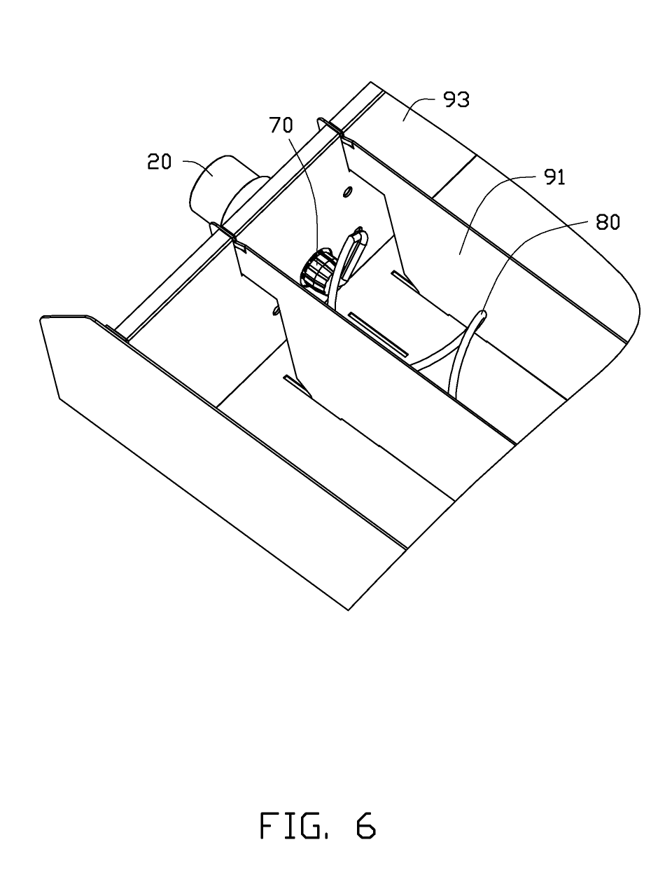

Referring to FIGS. 1 and 2, the chassis 90 comprises a side plate 93 and two separated plates 91. The two separated plates 91 are substantially parallel to each other and perpendicular to the side plate 93. The channel 901 is defined between the two separated plates 91. The side plate 93 defines an opening 931 communicating with the channel 901. Referring to FIG. 6, the two separated plates 91 are secured to the side plate 93, and the case 10 is secured to the side plate 93, and the mounting member 70 is received in the opening 931.

Referring to FIG. 5, the mounting member 70 includes a top wall 73 and a sidewall 71 surrounding the top wall 73. The through hole 731 is defined in the top wall 73. The sidewall 71 includes a first portion 711 and a second portion 713. The second portion 713 extends from the top wall 73, and the first portion 711 extends from the second portion 713. The diagonal surface 715 is defined on an inner surface of the second portion 713, and the plurality of inner threads 7111 are defined in an inner surface of the first portion 711.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic vending machine comprising:
a chassis, the chassis defining a channel configured for receiving products; and
a moving mechanism attached to the chassis; the moving mechanism comprising a moving member received in the channel, a driving assembly, and a mounting member attached to the driving assembly; the driving assembly being configured to rotate the moving member and comprising a claw member, the claw member comprising a plurality of clawers; the moving member being configured to move products when the moving member is rotated by the driving assembly;
wherein the mounting member is moveable relative to the claw member between a first position to a second position; when the mounting member is in the first position, and the moving member is located among the plurality of clawers; and when the mounting member is in a second position, the plurality of clawers are resiliently deformed by the mounting member to clamp the moving member.

2. The automatic vending machine of claim 1, wherein each of the plurality of clawers comprises a clamping portion, the mounting member surrounds on the clamping portion of each of the plurality of clawers and defines a diagonal surface, and the plurality of clawers are resiliently deformed by the diagonal surface when the mounting member is in the second position.

3. The automatic vending machine of claim 2, wherein each of the plurality of clawers defines a plurality of outer threads, and the mounting member defines a plurality of inner threads, the plurality of inner threads are engaged with the plurality of outer threads when the mounting member is moved between the first position and the second position.

4. The automatic vending machine of claim 2, wherein the mounting member further defines a through hole, and an end of the moving member extends through the through hole and located among the plurality of clawers.

5. The automatic vending machine of claim 2, wherein the driving assembly further comprises a rotating block and a sensor, the rotating block is secured to the plurality of clawers and is adapted to control rotations of the moving member, and the sensor is adapted to detect rotational movements of the rotating block.

6. The automatic vending machine of claim 5, wherein the rotating block comprises an arc surface and a flat surface, a resilient piece is attached to the sensor and abuts on one of the arc surface and the flat surface, and the rotating block slides against the sensor when the rotating block is being rotated.

7. The automatic vending machine of claim 6, wherein the driving assembly further comprises a case and a motor, the rotating block and the sensor are received in the case, the motor is secured to the case and configured to rotate the rotating block and the plurality of clawers relative to the case, and the sensor is slid relative to the case when the rotating block is being rotated.

8. The automatic vending machine of claim 7, wherein the driving assembly further comprises a resilient member and a post, the resilient member is secured to the case, the post is slidably secured to the case and abuts on the sensor, the resilient member is deformed to a first deformation when the resilient member abuts on the flat surface and to a second deformation when the resilient member abuts on the arc surface, and an amount of deformation of the first deformation is less than an amount of deformation of the second deformation.

9. The automatic vending machine of claim 2, wherein the chassis comprises a side plate and two separated plates, the case is secured to the side plate, the two separated plates are substantially parallel to each other and perpendicular to the side plate, the channel is defined between the two separated plates, and the two separated plates are secured to the side plate.

10. The automatic vending machine of claim 9, wherein the side plate defines an opening communicating with the channel, and the mounting member is received in the opening.

11. An automatic vending machine comprising:
a chassis, the chassis comprising two separated plates substantially parallel to each other; and
a moving mechanism attached to the chassis; the moving mechanism comprising a moving member located between the two separated plates, a driving assembly, and a mounting member attached to the driving assembly; the driving assembly being configured to rotate the moving member and comprising a claw member; the claw member comprising a plurality of clawers; the moving member being configured to move products when the moving member is rotated by the driving assembly;
wherein the mounting member is moveable relative to the claw member between a first position to a second position; when the mounting member is in the first position, and the moving member is located among the plurality of clawers; and when the mounting member is in a second position, the plurality of clawers are resiliently deformed by the mounting member to clamp the moving member.

12. The automatic vending machine of claim 11, wherein each of the plurality of clawers comprises a clamping portion, the mounting member surrounds on the clamping portion of each of the plurality of clawers and defines a diagonal surface, and the plurality of clawers are resiliently deformed by the diagonal surface when the mounting member is in the second position.

13. The automatic vending machine of claim 12, wherein each of the plurality of clawers defines a plurality of outer threads, and the mounting member defines a plurality of inner threads, the plurality of inner threads are engaged with the plurality of outer threads when the mounting member is moved between the first position and the second position.

14. The automatic vending machine of claim 12, wherein the mounting member further defines a through hole, and an end of the moving member extends through the through hole and located among the plurality of clawers.

15. The automatic vending machine of claim 12, wherein the driving assembly further comprises a rotating block and a sensor, the rotating block is secured to the plurality of clawers and is adapted to control rotations of the moving member, and the sensor is adapted to detect rotational movements of the rotating block.

16. The automatic vending machine of claim 15, wherein the rotating block comprises an arc surface and a flat surface, a resilient piece is attached to the sensor and abuts on one of the arc surface and the flat surface, and the rotating block slides against the sensor when the rotating block is being rotated.

17. The automatic vending machine of claim 16, wherein the driving assembly further comprises a case and a motor, the rotating block and the sensor are received in the case, the motor is secured to the case and configured to rotate the rotating block and the plurality of clawers relative to the case, and the sensor is slid relative to the case when the rotating block is rotated.

18. The automatic vending machine of claim 17, wherein the driving assembly further comprises a resilient member and a post, the resilient member is secured to the case, the post is slidably secured to the case and abuts on the sensor, the resilient member is deformed to a first deformation when the resilient member abuts against the flat surface and to a second deformation when the resilient member abuts against the arc surface, and an amount of deformation of the first deformation is less than an amount of deformation of the second deformation.

19. The automatic vending machine of claim 12, wherein the chassis further comprises a side plate substantially perpendicular to the two separated plates, the case is secured to the side plate, and the two separated plates are secured to the side plate.

20. The automatic vending machine of claim 19, wherein the side plate defines an opening between the two separated plates, and the mounting member is received in the opening.
